(19) United States
(12) Patent Application Publication
(10) Pub. No.: US 2010/0218168 A1
(43) Pub. Date: Aug. 26, 2010

(54) System and Method for Generating a Test Environment Script File

(76) Inventor: Jesus Orlando Gonzales, II, Foster City, CA (US)

Correspondence Address: AFS/ VISA, 666 THIRD AVENUE , 10TH FLOOR, NEW YORK, NY, 10017, US

(21) Appl. No.: 12/391,043

(22) Filed: Feb. 23, 2009

(51) Int. Cl. G06F 11/36

(52) U.S. Cl. 717/124

(57) ABSTRACT

A system for generating a test environment script file contains instructions for changing a job control language (JCL) file into a test JCL file to be run in a test environment. The system comprises a processor, a memory device for storing i) a common seed script file that specifies common settings and instructions for a plurality of different test environments and ii) an environment parameter file containing parameters for a specific test environment. A script generation module executable by the processor is adapted to generate the test environment script file based on the stored common seed script file and the stored environment parameter file.

### FIELD OF THE INVENTION

The present invention relates to computer systems, and more particularly to a system and method for generating a test environment script file containing instructions for changing a job control language (JCL) file into a test JCL file to be run in a test computing environment.

### BACKGROUND OF THE INVENTION

Making modifications or enhancements to software running in a live computer system requires careful testing and deployment, especially if the system is a large transaction processing system such as VisaNet™, which processes over one hundred million financial transactions (e.g., credit card transactions) per day. Typically, a set of software modification projects are initially tested in a test environment which emulates the actual transaction processing system.

Each software modification project typically adds or modifies a particular feature. An example of a software modification project may be a feature to add a new transaction type such that the computer system can handle prepaid card transactions in addition to credit/debit card transactions.

A software modification project may involve numerous jobs and procedures, each specified by a script which is used to generate a test Job Control Language (JCL) file for testing the software modification projects. Such scripts may be lengthy, and modification of the scripts to operate in specific environments is tedious, since the environmental parameters for a particular job is customized or tailored by the software tester for each specific environment.

Accordingly, in the prior art as shown in FIG. 1, software testers using a test computing environment 10 would select a particular environment script from hundreds of existing scripts 12-22 in a script library 24 in data storage 26, with each script previously customized for a particular computing environment with the necessary procedure calls and input/output parameters already specifying the particular computing environment. The selected environment script should be one that is the most similar to the new environment to be created. The software tester would then modify the selected script by providing manual script revision inputs 28 to a script editor 30 (e.g., text editor) to specify new jobs and procedures to be performed, and so a new environment script 34 would be created by modifying the selected environment script. The software tester would manually edit the selected script to specify the jobs and the computing environment in which the jobs are to be executed for a new software project.

Since such script editing takes time, software updating projects are delayed from being tested and from implementation. In addition, there may be dozens of different versions of a single script in the script library 24 at any specific time, requiring a time-consuming review of the scripts before use, potentially causing undesirable, improper, or inadvertent settings to be imported into the environment scripts.

Therefore, it is desirable to facilitate greater efficiency in the creation of environment scripts for new software projects.

### SUMMARY OF THE DISCLOSURE

According to one aspect of the invention, a system is provided for generating a test environment script file that contains instructions for changing a job control language (JCL) file into a test JCL file to be run in a test environment. The system comprises a processor and a memory device for storing: i) a common seed script file that specifies common settings and instructions for a plurality of different test environments; and ii) an environment parameter file containing parameters for a specific test environment. A script generation module executable by the processor is adapted to generate the test environment script file based on the stored common seed script file and the stored environment parameter file.

In a second aspect, the present invention provides a method of generating a test environment script file that contains instructions for changing a job control language (JCL) file into a test JCL file to be run in a test environment. The method comprises receiving a common seed script file that specifies common settings and instructions for a plurality of different test environments and an environment parameter file containing parameters for a specific test environment. The test environment script file is generated based on the stored common seed script file and the stored environment parameter file.

### BRIEF DESCRIPTION OF THE DRAWINGS

FIG. 1 illustrates a block diagram of an exemplary script generation system of the prior art.

FIG. 2 illustrates a block diagram of an exemplary computer-based system for use by the present invention.

FIG. 3 illustrates a block diagram of an exemplary script generation system according to an embodiment of the present invention.

FIGS. 4-5 illustrate portions of exemplary seed scripts.

FIG. 6 illustrates a portion of an exemplary environment parameter file.

FIGS. 7-8 illustrate portions of an exemplary environment seed testparm file.

FIG. 9 illustrates an exemplary flowchart of operation of the present invention.

FIG. 10 illustrates an exemplary flowchart of generation of the environment script file and environment testparm file.

### DETAILED DESCRIPTION OF THE INVENTION

For purposes of this application, the terms “code”, “program”, “application”, “software code”, “software module”, “module” and “software program” are used interchangeably to mean software instructions that are executable by a processor.

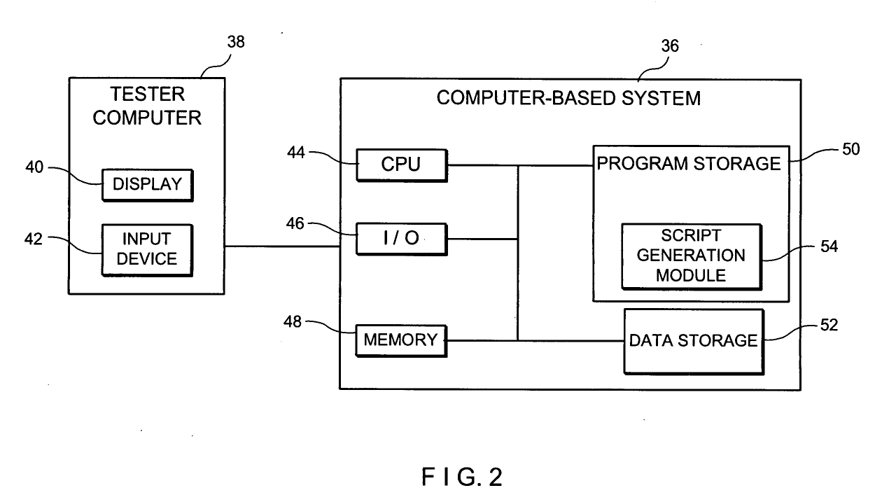

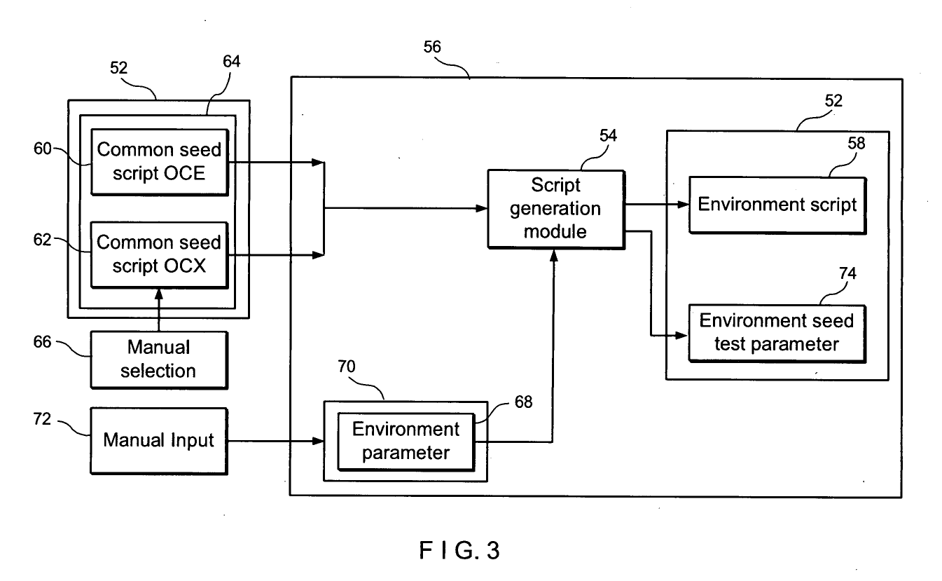

An exemplary block diagram of a computer-based system 36 is shown in FIG. 2 for use in the present invention, and shown in greater detail in FIG. 3. Referring to FIG. 2, the computer-based system 36 interacts with a tester computer 38 having a display 40 and an input device 42. The computer-based system 36 includes a CPU 44, an input/output (I/O) interface 46, and a memory 48, each of which is connected to a program storage unit 50 and a data storage unit 52. The program storage unit 50 includes a script generation module 54 of the present invention, as described herein. The computer-based system 36 may be a mainframe computer and/or a network of computing environments for interacting with the tester computer, which may be a terminal of the mainframe computer or network.

As shown in greater detail in FIG. 3, the computer-based system 36 provides a test computing environment 56 implemented in hardware and/or software for allowing the software tester to operate the predetermined script generation module 54 to generate a new environment script 58. The predetermined script generation module 54 may be implemented using source code in the restructured extended executor (REXX) interpreted computer programming language known in the art.

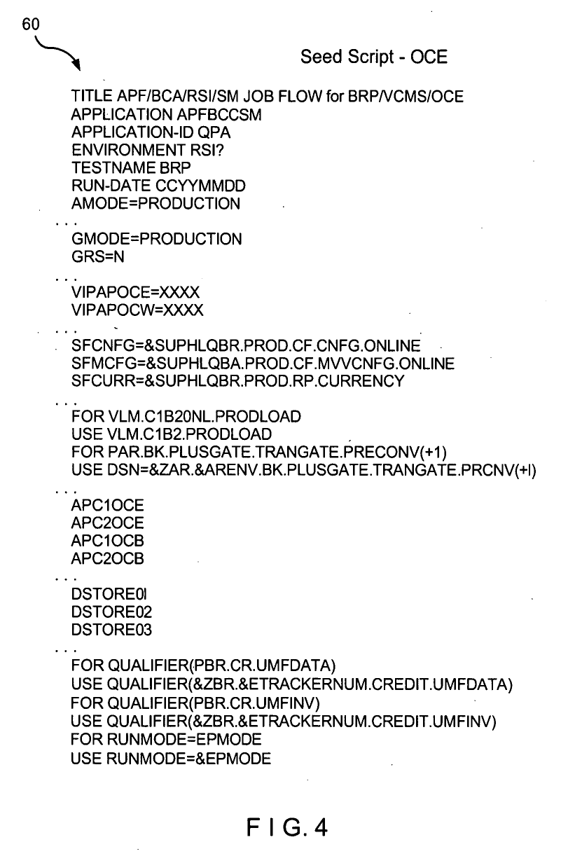

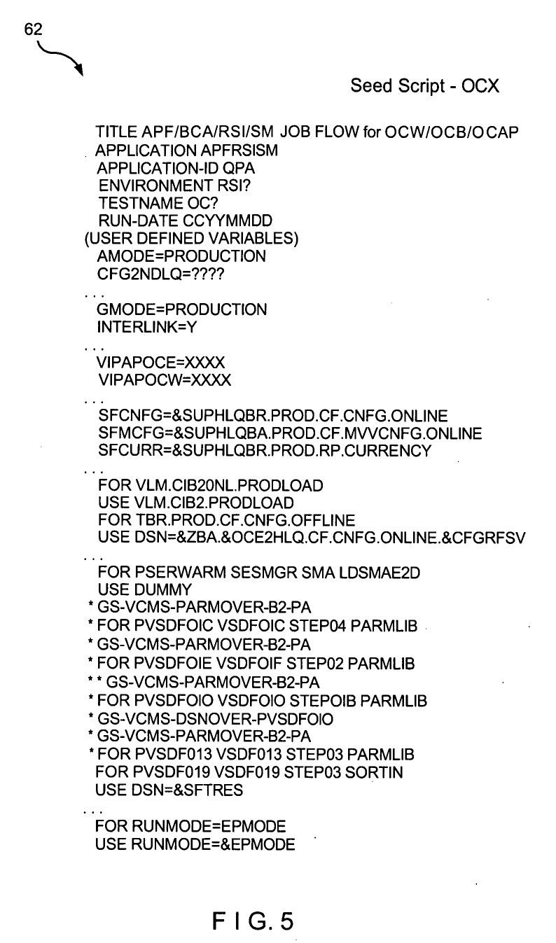

The predetermined script generation module 54 receives one of only two common seed scripts 60, 62 stored in a script library 64 in the data storage 52. Common seed scripts 60, 62 are seed scripts adapted for alternative computing environments (e.g., platforms) in which environment scripts are to be executed. Such common seed scripts 60, 62 specify lists of jobs and common settings for test applications across all environments and instructions which the predetermined script generation module 54 will process to generate the new environment script 58. The choice of which of the only two common seed scripts 60, 62 to employ is controlled by a manual selection 66. The manual selection 66 may be entered by the tester through the input device 42. Exemplary portions of common seed scripts 60, 62 are shown in FIGS. 4-5, respectively. In the depicted examples, the first common seed script 60 corresponds to an environment labeled, for example, “BRP” or “OCE”, while a second common seed script 62 corresponds to an environment labeled, for example, “OCX”. In the present invention, the common seed scripts 60, 62 remain unchanged, and so are available for the generation of any number of new environment scripts 58. For example, if a tester desires to generate a new environment script 58 for the OCX environment, the tester enters a manual selection 66 indicating which of the common seed scripts 60, 62 to use, for example, the second common seed script 62 corresponding to the OCX environment. Therefore, the present invention avoids ambiguity or confusion for the tester as to which of the hundreds of the pre-existing environment scripts 12-22 to choose which would match the desired environmental parameters and characteristics to be specified in the new environment script 58.

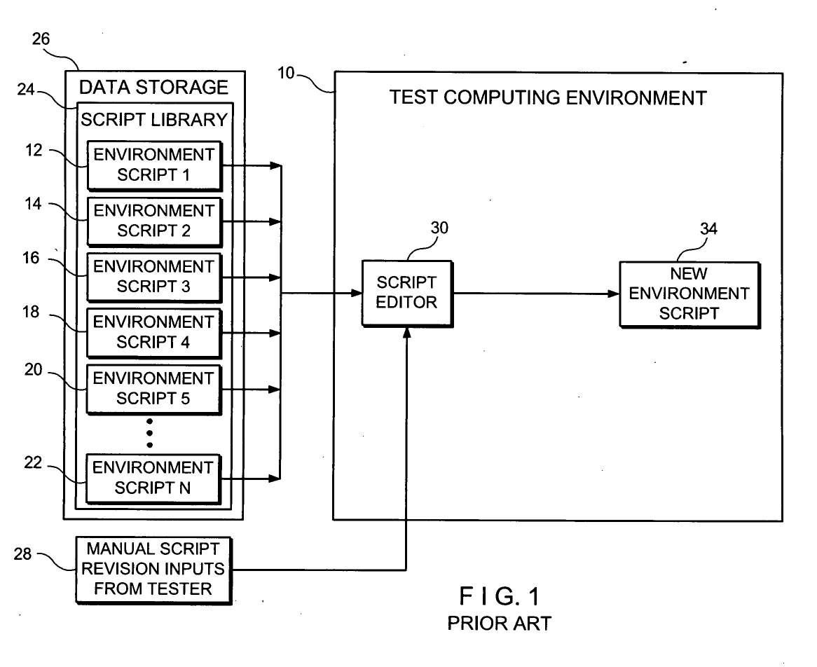

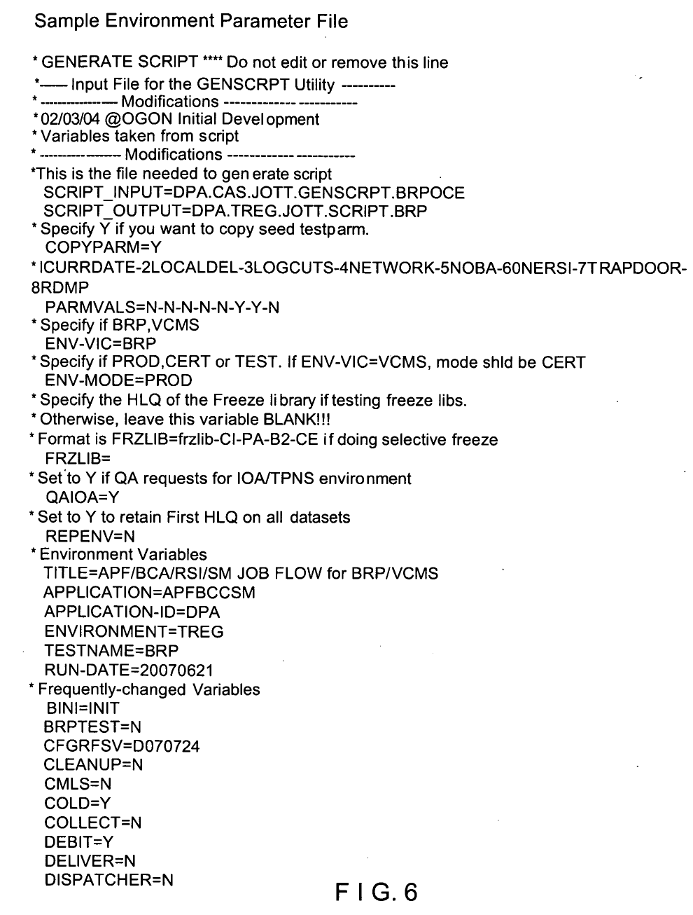

In contrast to the prior art in which hundreds of previous environment scripts 12-22 (FIG. 1) were used and no common seed scripts were used, the present invention may employ only a single model environment script. The resulting script typically includes default values for variables. The tester may, via manual input 72, select and change the values of the variables to correspond to the environment. The changes input are delivered through a script editor 70 (e.g., text editor) which creates an environment parameter file 68, an exemplary portion of which is shown in FIG. 6. The environment parameter file 68 may include libraries and library concatenations to specify locations of libraries and procedure calls, environment library parameter setting and may also include settings that determine whether a list of jobs from a RUNORDER file are to be added in a ‘JOB RUN ORDER’ section of the new environment script 58. This section adds certain required conditions for the execution of specific jobs.

For example, APPLICATION-ID, ENVIRONMENT, and TESTNAME shown in FIG. 6 are example variables that are changed using the environment parameter file 68 to modify one of the common seed scripts 60, 62 in order to generate the new environment script file 58 which is specific to the environment. The APPLICATION-ID variable is a first level qualifier of the environment, the ENVIRONMENT variable is a second level qualifier of the environment, and the TESTNAME variable is to differentiate environments with the same APPLICATION-ID and ENVIRONMENT; for example, if the tester is testing new applications on multiple days, the tester may set the value of the variable TESTNAME as DAY1 for the first day of execution, and may set TESTNAME to DAY2 for the second day, and so on. As an example, the command lines of the OCE seed script 60 shown in FIG. 4:

APPLICATION-ID=QPA

ENVIRONMENT=RSI?

TESTNAME=BRP

RUN-DATE=CCYYMMDD

are set in the environment parameter file 68 to generate the new environment script file 58 having the above settings for the variables APPLICATION-ID, ENVIRONMENT, TESTNAME, and RUN-DATE.

The predetermined script generation module 54 of the present invention employs the environment parameter file 68 to generate the new environment script 58 in conjunction with the selected one of the common seed scripts 60, 62. The environment parameter file 68 is input to the predetermined script generation module 54 from the file editor 70, known in the art, such as the System Productivity Facility (SPF) Editor, which may be a default file editor on the Multiple Virtual Storage (MVS) operating system, commercially available from “INTERNATIONAL BUSINESS MACHINES”™.

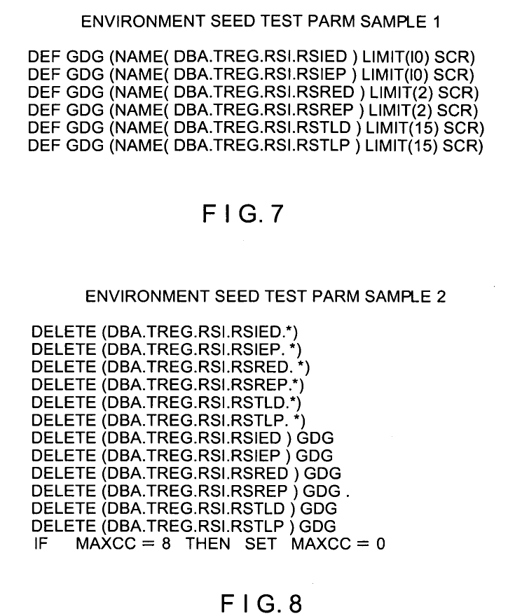

In the process of generating the new environment script 58, the predetermined script generation module 54 also generates at least one file including environment seed test parameter file 74 associated with the new environment script 58. Samples of an exemplary environment seed test parameters file are shown in FIGS. 7-8. The first sample shown in FIG. 7 includes a number of definition commands that define generation data groups (GDGs) which are groups of files that can be referred to together as a group in an environment. The second sample includes a number of delete commands that delete libraries (DBAs) and generation data groups (GDGs).

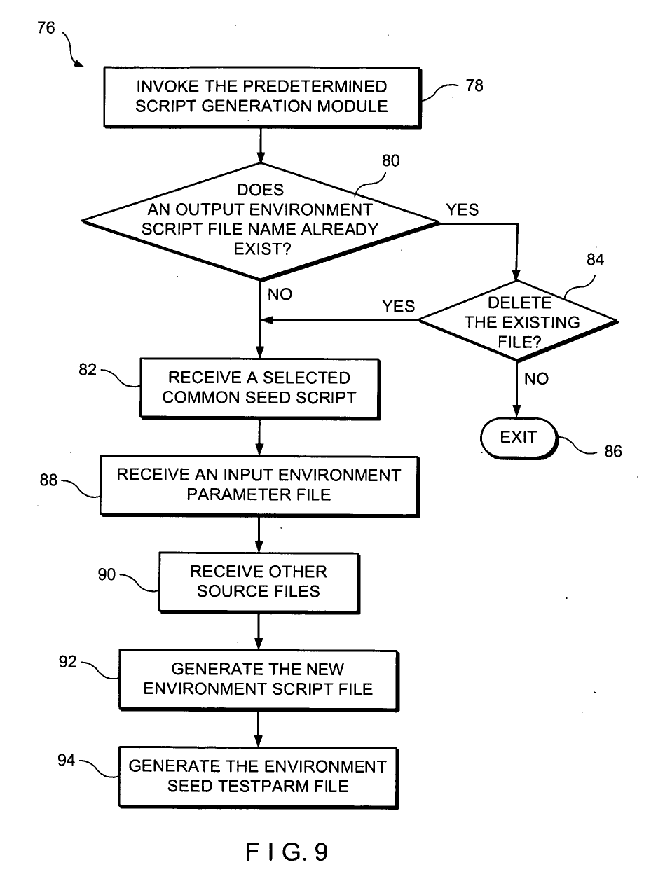

FIG. 9 illustrates an exemplary flowchart of the method 76 of operation of the present invention, in which the predetermined script generation module 54 is invoked in step 78 typically by a tester and a proposed output environment script file name is submitted. In step 80, a check is performed to determine if the proposed output environment script file name to be generated already exists in the data storage 52. If not, the method proceeds to step 82 to begin receiving inputs including the selected common seed script.

However, if a proposed file name already exists, the method 76 prompts the tester in step 84 whether or not to delete or overwrite the existing file in the data storage 72. If deletion is not desired, the method exits in step 86, or alternatively loops back to step 78 to restart the method and to prompt the tester to input a new name for the output environment script file.

Otherwise, if the tester chooses in step 84 to delete the existing file, the method deletes the file to be replaced with the new output environment script file to be generated, and the method proceeds to step 82. The method then receives a selected common seed script in step 82, receives an input environment parameter file 68 in step 88, and optionally receives other source files in step 90, for example, files specifying the settings specific to the test bed environment.

The method generates the new environment script file 58 in step 92, and generates the environment seed test parameter file 74 in step 94, with the new environment script file 58 and the environment seed test parameter file 74 being output for use in the test computing environment 56, for example, to generate JCLs for executing test applications. The test parameters in the environment seed test parameter file 74 may include both seed test parameters (not used to directly set actual test parameters) and environment test parameters (used to directly set actual test parameters). The seed test parameters are generated first, if a COPYPARM variable is set to Y in a GENERATE member, which is set in the environment parameter file 68.

Some of the variables in the GENERATE member affect how the seed test parameters are created. For example, the values of the PARMVALS variable, such as:

PARMVALS=N-N-N-N-N-Y-Y-N

may be used to control how specific seed test parameters specified by the set of variables 1CURRDATE-2LOCALDEL-3LOGCUTS-4NETWORK-5NOBA-60NERSI-7TRAPDOOR-8RDMP. Accordingly, by setting the first value as Y (CURRDATE), it will use the current (or system) date, which will override the RUN-DATE specified. LOCALDEL specifies that a collection of data to an APF variable is to be deleted afterwards; LOGCUTS indicates whether the system is to have multiple tranlog cutoffs; NETWORK indicates whether a connection to a computing platform is set. NOBA determines whether BA versus BD files are selected directly, if NOBA=Y, BA files are consolidated to create a BD file; ONERSI selects one of the two images of the record settlement interface (RSI); TRAP DOOR sets up trapdoor settings for the authorized program facility (APF); and RDMP creates the research dumps. Thus, in the example above, since Y is set on the sixth and seventh place, this means that the tester wants ONERSI (single image RSI) and TRAPDOOR (which means to setup the trapdoor options in APF), while the other parameter values are set to N, which means they are turned off. After the environment seed test parameter file 74 is created, environment test parameter files are also created when a GENPARM module is invoked in connection with or independent of the predetermined script generation module 54.

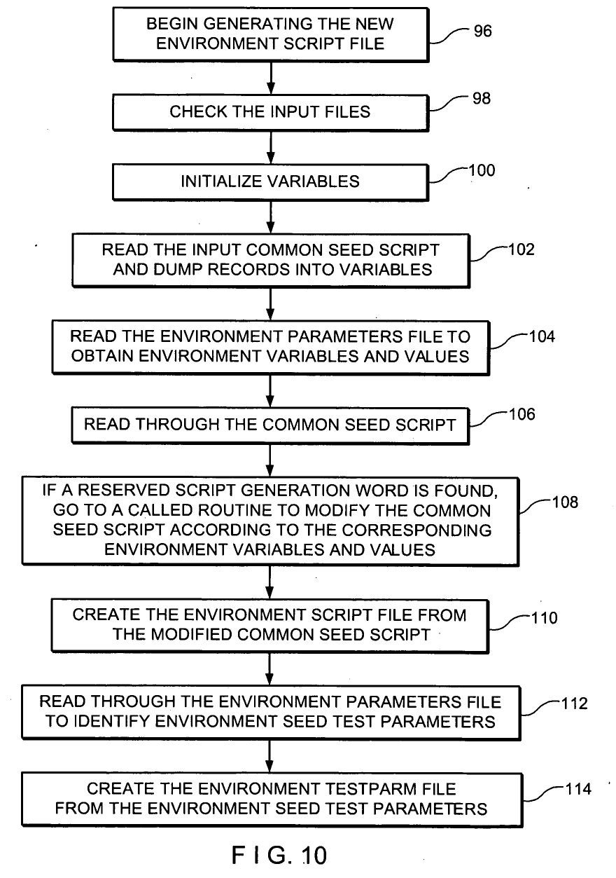

FIG. 10 illustrates an exemplary flowchart of steps 92-94 in greater detail for the generation of the environment script file 58 and environment seed test parameter file 74. The method begins generating the new environment script file 58 in step 96, for example, by receiving the input files in steps 82-90 shown in FIG. 9. The method then checks the input files in step 98, for example, to determine if all of the files are received, and to validate that the input files include one of the two common seed scripts 60, 62.

The method then initializes variables in step 100 which are required in the new environment script 58 to be generated, with such variables specified by the input environment parameter file 68, the selected one of the common seed scripts 60, 62, and values of the variables to be used in the new environment script 58 specified by the user when creating the environment parameter file 68. The GENERATE member in the environment parameter file 68 is used as a guide to create the entire environment. Some variables in the GENERATE member are used in generating the seed test parameters, and some variables are used when the predetermined script generation module 54 detects a “*GS-” string in the selected seed script, as described below. The method then reads the selected common seed script 60, 62 and dumps records and other data specified by the selected common seed script 60, 62 into the initialized variables in step 102. The step 102 of dumping includes detecting the lines and records encountered in the selected common seed script 60, 62, and copying such lines and records into intermediate or stem variables in memory which will then be read and re-processed subsequently by the inventive system and method when generating the new environment script 58.

The method then reads the environment parameter file 68 in step 104 to obtain environment variables and values which are to be used in modifying the selected common seed script 60, 62 and the initialized variables with the values being set specifically for an environment to be created. For example, in an exemplary line of code:

SCRIPT_INPUT=DPA.CAS.JOTT.GENSCRPT.BRPOCE

the left side SCRIPT_INPUT represents a variable, and the right side DPA.CAS.JOTT.GENSCRPT.BRPOCE is the intended value of the variable. Accordingly, when the method of the present invention encounters the variable SCRIPT_INPUT in the new environment script 58, in each instance, the value DPA.CAS.JOTT.GENSCRPT.BRPOCE is substituted for the variable SCRIPT_INPUT.

The method then reads through the selected common seed script 60, 62 in step 106, and systematically generates the new environment script 58 while detecting a reserved script generation word in step 108. For example, as shown in FIG. 6, if a reserved script generation word is found, such as “GS” as shown in the selected common seed 62 script shown in FIG. 5, the method calls a routine to modify a draft of the new environment script 58 based on a copy of the common seed script 62. The routine replaces such reserved script generation words and their command lines with new procedures or variables according to the corresponding environment variables and values specified in the environment parameter file 68. For example, the exemplary code of common seed script 62 shown in FIG. 5 includes a series of lines beginning with “*GS” between the lines starting with “USE DUMMY” and “FOR PVSDF019”. During execution of step 108, when each line is encountered beginning with “*GS”, a procedure is called as specified in the “GS” line and the next line for modifying the environment script file 58 appropriately. When such procedures are called and processed, they are not copied or placed into the environment script file 58 being created, as shown in the exemplary environment script file in FIG. 6. Accordingly, there are no corresponding commands in the exemplary environment script file in FIG. 6 between the lines starting with “USE DUMMY” and “FOR PVSDF019”, since the reserved script generation words have been processed for creating and customizing the new environment script file 58 based on the common script file 62 and the environment parameter file 68.

After the entire common seed script 60, 62 is read and processed to create a draft new environment script file 58 in the memory 48, the method finalizes the script generation process in step 110 to create the new environment script 58 from the modification of data from the common seed script 60, 62. The method then proceeds to step 112 to read through the environment parameter file 68 to identify environment seed test parameters associated with the new environment script 58, and the method creates the environment test parameter file 74 from the environment seed test parameters in step 114.

The automated creation of the new environment script file 58 provides greater efficiency, in which the tester only has to choose which common seed script file 60, 62 to specify the environment, and then only has to create an environment parameter file 68 instead of creating or modifying a prior version of an environment script file.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for generating a test environment script file containing instructions for changing a job control language (JCL) file into a test JCL file to be run in a test environment, the system comprising:
a processor;
a memory device for storing a common seed script file specifying common settings and instructions for a plurality of different test environments and for storing an environment parameter file containing parameters for a specific test environment; and
a script generation module executable by the processor and adapted to generate the test environment script file based on the stored common seed script file and the stored environment parameter file.

2. The system according to claim 1, wherein:
the script generation module generates further generates an environment seed test parameters file that is used to configure parameters for testing the test JCL file.

3. The system according to claim 1, wherein the script generation module generates the test environment script file based on a user selected one of:
a first common seed script file specifying common settings and instructions for a plurality of different test environments for a first computing platform; and
a second common seed script file platform specifying common settings and instructions for a plurality of different test environments for a second computing platform different from the first computing platform.

4. The system according to claim 3, wherein the script generation module generates the test environment script file based on the environment parameter file that contains parameters that have been manually entered by a user.

5. The system according to claim 1, wherein the script generation module is adapted to:
initialize new variables specified by the common seed script file and the environment parameter file; and
enter data specified in the common seed script file into the initialized variables.

6. A method of generating a test environment script file containing instructions for changing a job control language (JCL) file into a test JCL file to be run in a test environment, the method comprising:
receiving a common seed script file specifying common settings and instructions for a plurality of different test environments and an environment parameter file containing parameters for a specific test environment; and
generating the test environment script file based on the stored common seed script file and the stored environment parameter file.

7. The method according to claim 6, wherein the step of generating the test environment script file further includes generating an environment seed test parameters file that is used to configure parameters for testing the test JCL file.

8. The method according to claim 6, wherein the step of generating the test environment script file includes generating the test environment script file based on a user selected one of:
a first common seed script file specifying common settings and instructions for a plurality of different test environments for a first computing platform; and
a second common seed script file platform specifying common settings and instructions for a plurality of different test environments for a second computing platform different from the first computing platform.

9. The method according to claim 7, prior to generating the test environment script file, further comprising:
receiving manual parameter inputs from a user for the environment parameter file.

10. The method according to claim 6, further comprising:
initializing new variables specified by the common seed script file and the environment parameter file; and
entering data specified in the common seed script file into the initialized variables.
